(19) United States
(12) Patent Application Publication
(10) Pub. No.: US 2026/0362089 A1
(43) Pub. Date: Nov. 12, 2026

(54) SPATIAL ANCHOR MANAGEMENT METHOD AND SPATIAL MAP MANAGEMENT METHOD AND COMMUNICATION SYSTEM THEREFOR

(71) Applicant: Electronics and Telecommunications Research Institute, Daejeon (KR)

(72) Inventors: Byungjun AHN, Daejeon (KR); Seung-Ik LEE, Daejeon (KR)

(73) Assignee: Electronics and Telecommunications Research Institute, Daejeon (KR)

(21) Appl. No.: 19/674,293

(22) Filed: May 12, 2026

(30) Foreign Application Priority Data
May 12, 2025 (KR) 10-2025-0061003
May 11, 2026 (KR) 10-2026-0084617

(51) Int. Cl. H04W 4/029

(52) U.S. Cl. CPC H04W 4/029

(57) ABSTRACT

According to exemplary embodiments of the present disclosure, a method performed by a spatial anchor management server includes receiving a request for creating a spatial anchor associated with an object in a spatial map, the request including spatial map information, and creating the spatial anchor associated with the object based on the spatial map information included in the request. The spatial map information includes a spatial map identifier identifying the spatial map; and an object identifier identifying the object included in the spatial map.

### CROSS-REFERENCE TO RELATED APPLICATIONS

This application claims priority to Korean Patent Applications No. 10-2025-0061003 filed on May 12, 2025, and No. 10-2026-0084617 filed on May 11, 2026, with the Korean Intellectual Property Office (KIPO), the entire contents of which are hereby incorporated by reference.

### BACKGROUND

### 1. Technical Field

The present disclosure relates to the field of communication technologies, and more particularly, to a technology for providing an application service linked to location-based spatial information of a communication terminal by using a communication network.

### 2. Related Art

The matters described in this section merely provide background information regarding exemplary embodiments and do not constitute the related art.

In a mobile communication network, electronic devices such as a base station (BS) and a user equipment (UE) perform wireless communication with each other in order to transmit or receive data between each other. Sensing is a process for obtaining information regarding surroundings of a device. Sensing may also be used to detect information regarding an object, such as a location, speed, distance, direction, shape, texture, and so on. This information may be used for generating a spatial map describing, in a digital format, an environment of a given three-dimensional (3D) physical space. The spatial map may be used for providing a location-based AR or XR service. In this case, spatial anchors are obtained by associating application service information with a specific location in a virtual or real 3D space, and may be used for identifying and accessing an associated service. Spatial anchors are a concept introduced for a connection or association between a virtual or real space and media content in an AR/VR environment.

Utilization of spatial map information and spatial anchor information is gradually increasing in various convergence/combination fields enabled by 5G/5G advanced mobile communication technologies, and spatial map information and spatial anchor information tend to be regarded as major application service resources.

Conventional spatial anchors are defined to be configured only at fixed locations in a three-dimensional space, and thus have a limitation in that configuring a spatial anchor on a moving object is not easy and spatial anchors are utilized only in specific content.

Accordingly, there is a need for an improvement for such a problem.

### SUMMARY

The present disclosure is directed to a spatial anchor management method for associating an object on a spatial map with application service information.

The present disclosure is directed to a method capable of overcoming a limitation of the related art in which a spatial anchor is defined based on a fixed three-dimensional spatial position, and capable of configuring a spatial anchor for a movable or trackable object.

The present disclosure is directed to a method in which a spatial anchor is associated with a specific object defined within a spatial map by using spatial anchor information including an object identifier.

The present disclosure is directed to a method capable of dynamically managing a spatial anchor in response to a position change of a moving object through a cooperative operation between a spatial map management server and a spatial anchor management server.

The present disclosure is directed to a method capable of appropriately updating a state of a spatial anchor according to a change of an object in a spatial map, such as creation, movement, deletion, and so on.

According to exemplary embodiments of the present disclosure, a method performed by a spatial anchor management server may include receiving a request for creating a spatial anchor associated with an object in a spatial map, the request including spatial map information; and creating the spatial anchor associated with the object based on the spatial map information included in the request. The spatial map information may include a spatial map identifier identifying the spatial map; and an object identifier identifying the object included in the spatial map.

In the method according to exemplary embodiments of the present disclosure, in the creating of the spatial anchor associated with the object, the spatial anchor may be created based on spatial map position information including one or more of: the spatial map identifier; a spatial map layer identifier and localization information corresponding to the spatial map layer identifier; or the object identifier.

In the method according to exemplary embodiments of the present disclosure, the localization information may include a three-dimensional position and a pose of the object.

The method according to exemplary embodiments of the present disclosure may further include receiving a request for discovering a spatial anchor of interest, the request for discovering the spatial anchor of interest including a request identifier, and a spatial anchor discovery filter; and transmitting a response for discovering the spatial anchor of interest. The response may include one or more of: position information of the spatial anchor of interest in three-dimensional space; or spatial map position information including a corresponding spatial map corresponding to the spatial anchor of interest.

The method according to exemplary embodiments of the present disclosure, may further include validating the request for discovering the spatial anchor of interest based on the request identifier and security credential of a requestor included in the request for discovering the spatial anchor of interest.

In the method according to exemplary embodiments of the present disclosure, the spatial anchor discovery filter may include one or more of: an identifier of the spatial anchor of interest; an area of interest; a service identifier identifying a vertical application layer (VAL) service; an associated name indicating a name associated with the spatial anchor of interest; or application specific spatial anchor information.

In the method according to exemplary embodiments of the present disclosure, the spatial map position information included in the response may include one or more of: a spatial map identifier identifying the corresponding spatial map; a spatial map layer identifier identifying a layer being included in the corresponding spatial map and including the spatial anchor of interest; or an object identifier identifying an object associated with the spatial anchor of interest being included in the corresponding spatial map.

The method according to exemplary embodiments of the present disclosure may further include, when the spatial anchor of interest is associated with a movable and trackable object, obtaining, from a spatial map management server, current position information of the movable and trackable object associated with the spatial anchor of interest. The response for discovering the spatial anchor of interest may further include the spatial map position information including the current position information of the movable and trackable object.

The method according to exemplary embodiments of the present disclosure may further include: receiving a request for subscribing to a spatial anchor of interest, the request for subscribing including a spatial anchor filter including an area of interest; and when the spatial anchor of interest is associated with a movable and trackable object, obtaining, from a spatial map management server, current position information of the movable and trackable object associated with the spatial anchor of interest. The current position information may be used for determining whether the spatial anchor of interest is within the area of interest. A response to the request for subscribing may include information associated with the spatial anchor of interest based on the current position information.

The method according to exemplary embodiments of the present disclosure may further include: monitoring a location of a user equipment (UE) and a position of the movable and trackable object associated with the spatial anchor of interest; and determining whether the spatial anchor of interest is in-range or out-of-range of the UE based on the current position information of the movable and trackable object obtained from the spatial map management server, and mobility prediction information of the movable and trackable object obtained from the spatial map management server.

According to exemplary embodiments of the present disclosure, a method performed by a spatial map management server may include: receiving a request for subscribing to a spatial map event, the request including a spatial map identifier identifying a spatial map and event information; and transmitting a response to the request for subscribing to the spatial map event. The response may include one or more of: a subscription identifier based on a successful validation of the request; or an indication of failure and a reason for failure for a validation of the request.

The method according to exemplary embodiments of the present disclosure may further include: authorizing a requestor based on a requestor identifier and security credential for the requestor included in the request; and validating the request based on the authorization of the requestor.

In the method according to exemplary embodiments of the present disclosure, the spatial map event may include a “change of objects” event indicating that one or more objects in the spatial map are added, removed, or changed in position, direction, or velocity.

The method according to exemplary embodiments of the present disclosure may further include: obtaining position information, direction information, and velocity information of one or more trackable objects included in the spatial map from a core network or a location management service.

The method according to exemplary embodiments of the present disclosure may further include: detecting a change of the one or more trackable objects in the spatial map based on the position information, the direction information, and the velocity information of the one or more trackable objects; and transmitting a notification message indicating the detected change of the one or more trackable objects to a subscriber.

In the method according to exemplary embodiments of the present disclosure, the notification message may further include estimated duration of tracking indicating a duration for which the one or more trackable objects remain in the spatial map.

The method according to exemplary embodiments of the present disclosure may further include: performing mobility prediction of the one or more trackable objects based on data analytics using the position information, the direction information, and the velocity information of the one or more trackable objects. The notification message may be generated based on the mobility prediction. Monitoring of the spatial map event may be performed until a tracking end condition associated with the one or more trackable objects is satisfied.

According to exemplary embodiments of the present disclosure, a mobile communication network system may include a spatial anchor management server, being operated by at least one entity. The spatial anchor management server may be configured to: receive a request for creating a spatial anchor associated with an object in a spatial map, the request including spatial map information; and create the spatial anchor associated with the object based on the spatial map information. The spatial map information may include a spatial map identifier identifying the spatial map and an object identifier identifying the object included in the spatial map.

In the mobile communication network system according to exemplary embodiments of the present disclosure, the spatial anchor management server may be further configured to: receive a request for discovering a spatial anchor of interest, the request including a spatial anchor discovery filter; validate the request for discovering the spatial anchor of interest based on a request identifier and a security credential of a requestor included in the request; and transmit a response for discovering the spatial anchor of interest.

In the mobile communication network system according to exemplary embodiments of the present disclosure, the spatial anchor management server may be further configured to: receive a request for subscribing to a spatial anchor of interest, the request including a spatial anchor filter including an area of interest; and when the spatial anchor of interest is associated with a movable and trackable object, obtain, from a spatial map management server, current position information of the movable and trackable object associated with the spatial anchor of interest. A response to the request for subscribing may include information associated with the spatial anchor of interest based on the current position information.

According to exemplary embodiments of the present disclosure, by configuring a spatial anchor based on an object rather than a fixed three-dimensional position, an application service may be continuously provided even for a movable object.

According to exemplary embodiments of the present disclosure, whether a spatial anchor is available for an application may be determined by using information regarding an object, such as a position, a direction, a velocity, and so on, provided from a spatial map management server, and thus service accuracy may be improved.

According to exemplary embodiments of the present disclosure, by managing a spatial anchor based on an object identifier, service association for the same object may be clearly maintained.

According to exemplary embodiments of the present disclosure, when an object is removed or changed in a spatial map, a spatial anchor may be managed by reflecting the removal or the change, and thus unnecessary maintenance or an error of a spatial anchor may be prevented.

According to exemplary embodiments of the present disclosure, a utilization range of a spatial anchor may be expanded based on continuous monitoring and data analytics (e.g., mobility prediction) for a trackable object.

### BRIEF DESCRIPTION OF DRAWINGS

FIG. 1 is a diagram conceptually illustrating multiple spatial maps defined within a given region for a method for providing an application service linked to location-based spatial information according to an exemplary embodiment of the present disclosure.

FIG. 2 is a diagram illustrating a functional model for an On-network Spatial Anchors service according to an exemplary embodiment of the present disclosure.

FIG. 3 is a diagram illustrating an interaction between a spatial anchor management server and a spatial map management server according to an exemplary embodiment of the present disclosure.

FIG. 4 is a diagram illustrating a service based architecture for a Spatial Anchors service according to an exemplary embodiment of the present disclosure.

FIG. 5 is a diagram illustrating a spatial anchor generation/creation procedure according to an exemplary embodiment of the present disclosure.

FIG. 6 is a diagram illustrating a spatial anchor discovery procedure according to an exemplary embodiment of the present disclosure.

FIG. 7 is a diagram illustrating a spatial anchor subscription procedure according to an exemplary embodiment of the present disclosure.

FIG. 8 is a diagram illustrating a functional model for an On-network Spatial Map service according to an exemplary embodiment of the present disclosure.

FIG. 9 is a diagram illustrating a service based architecture for a Spatial Map service according to an exemplary embodiment of the present disclosure.

FIG. 10 is a diagram illustrating a Spatial Map event subscription procedure according to an exemplary embodiment of the present disclosure.

FIG. 11 is a diagram illustrating a Spatial Map event notification procedure according to an exemplary embodiment of the present disclosure.

FIG. 12 is a conceptual diagram illustrating an example of a generalized computing system in which a vertical application layer (VAL) server entity, a spatial map management server (SMS) entity, a spatial map client (SMC) entity, a spatial anchor management server (SAS) entity, a spatial anchor client (SAC) entity, an entity within a core network, or a part thereof capable of performing at least a part of procedures of FIGS. 1 to 11 is implemented.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Meanwhile, even though a technology has been publicly known before the filing date of the present application, the technology may be included as a part of the configuration of the present disclosure when necessary, and the technology will be described in this specification within a range not obscuring the gist of the present disclosure. However, in describing the configuration of the present disclosure, a detailed description of matters that are publicly known before the filing date of the present application and may be obviously understood by those skilled in the art may obscure the gist of the present disclosure, and thus an excessively detailed description of the publicly known technology will be omitted.

However, the gist of the present disclosure is not intended to claim rights to these publicly known technologies, and contents of the publicly known technologies may be included as a part of the present disclosure within a range not departing from the gist of the present disclosure.

Hereinafter, preferred exemplary embodiments of the present disclosure will be described in more detail with reference to the accompanying drawings. In describing the present disclosure, in order to facilitate overall understanding, the same reference numerals are used for the same components in the drawings, and repeated descriptions of the same components are omitted.

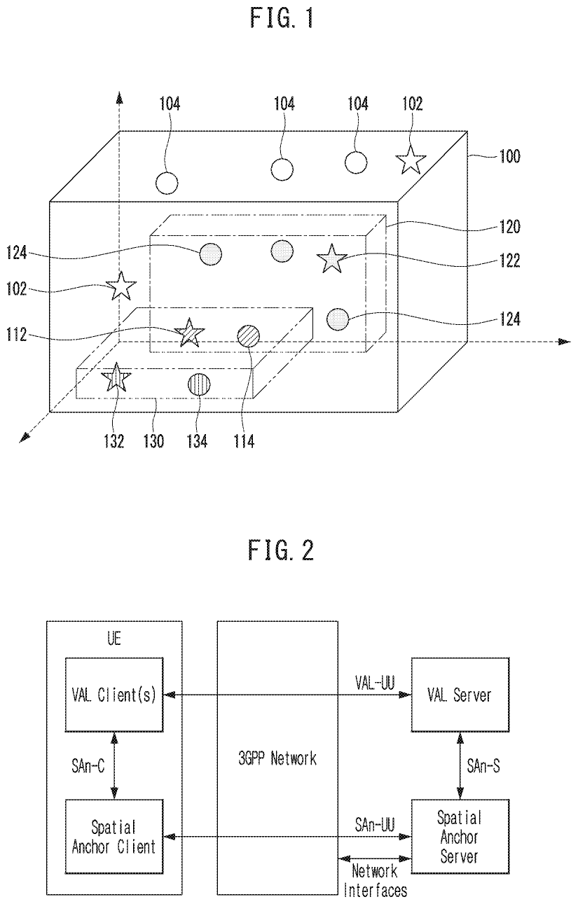

FIG. 1 is a diagram conceptually illustrating multiple spatial maps defined within a given region for a method for providing an application service linked to location-based spatial information according to an exemplary embodiment of the present disclosure.

According to exemplary embodiments of the present disclosure, a method for defining multiple spatial maps and a plurality of spatial anchors within a given area of interest and managing a correlation between the multiple spatial maps and the plurality of spatial anchors may be implemented.

As shown in FIG. 1, multiple spatial maps within a given area of interest 100 and a plurality of spatial anchors corresponding to each of the spatial maps are illustrated.

The given area of interest 100 may itself be regarded as one spatial map.

A first spatial map 120 and a second spatial map 130 may be defined within the given area of interest 100.

Objects illustrated in FIG. 1 may indicate various things or persons within a real environment/a virtual environment, such as a chair, a desk, a pet such as a dog/cat (including an animal in a virtual world), a robot, a kiosk, humans without UE, a vehicle, and so on.

An anchor 112 of a first category may indicate an anchor commonly belonging to the first spatial map 120 and the second spatial map 130.

An object 114 of the first category may indicate an object commonly belonging to the first spatial map 120 and the second spatial map 130.

An anchor 122 of a second category may indicate an anchor belonging to the first spatial map 120.

An object 124 of the second category may indicate an object belonging to the first spatial map 120.

An anchor 132 of a third category may indicate an anchor belonging to the second spatial map 130.

An object 134 of the third category may indicate an object belonging to the second spatial map 130.

An anchor 102 of a fourth category may indicate an anchor belonging to the area of interest 100 but not belonging to either the first spatial map 120 or the second spatial map 130.

An object 104 of the fourth category may indicate an object belonging to the area of interest 100 but not belonging to either the first spatial map 120 or the second spatial map 130.

A meaning of a spatial map and a spatial anchor and a process for defining a correlation between the spatial map and the spatial anchor may be as follows.

A spatial anchor may be defined as “a connection between service information, which is obtained by associating application service information with a specific location within a space (3D), capable of being used for identifying and accessing an associated service and a specific location within a 3D space (e.g., information required for accessing AR media content).”

An application provider may use a spatial anchor management service, such as creation/generation, update, deletion/removal, and so on, of a spatial anchor by using location information capable of managing application content and a service in a 3GPP system. In addition, an application consumer may search for and access the application content and the service in a location-based manner by using a spatial anchor.

1) A spatial anchor creator may create/generate a spatial anchor together with a location within a 3D space. In this case, content to be shared, a location, a constraint (e.g., information regarding with whom the spatial anchor is to be shared), and additional information may be determined.

2) A spatial anchor consumer may recognize an anchor associated with a location within a 3D space and may obtain related information by using the spatial anchor.

In order to create a spatial anchor, a spatial anchor creator may identify a location of a product and may create a new spatial anchor by associating the location with product information. The spatial anchor creator may adjust/update or completely delete the spatial anchor based on location information or service information. A spatial anchor consumer may search for information regarding the spatial anchor.

Such a process may be implemented in a service enabler architecture layer (SEAL). For example, a spatial anchor management function may be supported in addition to a known SEAL function (e.g., location management).

In exemplary embodiments of the present disclosure, “spatial map management” and “spatial anchor management” may be implemented as independent servers in various exemplary embodiments or may be implemented as collocated entities, as respective independent logical entities.

The spatial map management and the spatial anchor management may be executed in respective servers, or may be independently executed in a spatial map management function module and a spatial anchor function module within one server.

In alternative exemplary embodiments of the present disclosure, spatial map management and/or spatial anchor management may operate as separate function modules within one server.

In exemplary embodiments of the present disclosure, a spatial map management server may be implemented as one of SEAL servers, such as a SEAL LM (Location Management) server.

In exemplary embodiments of the present disclosure, a spatial anchor management server may also be implemented as one of the SEAL servers.

A SEAL layer is a layer included in a mobile communication network and may provide an application-specific advanced function between a core network and an application.

As one example of a spatial anchor support service, a localized mobile metaverse service use case may be considered. In this use case, a plurality of spatial anchors and corresponding services may be provided based on spatial maps associated with a location at which a user is present. In this use case, one or more mobile metaverse services may be combined based on information regarding an accurate location, a pose, a gaze, and so on, of a user derived based on the spatial map, thereby forming and providing a service experience based on spatial localization of a field of view of the user.

As one example of a spatial anchor support service, a use case for recommending, to a user, a spatial anchor of a restaurant during evening hours based on a previous search history in order to provide an enhanced service experience to the user based on the spatial anchor may be considered. In this use case, an intelligent spatial anchor service recommendation capable of helping the user and improving a service experience may be provided.

A consumer consuming a generated spatial anchor may use spatial anchor analytics, such as user density per spatial anchor, spatial anchor density at a specific location, a number of accesses to a spatial anchor for service improvement, spatial anchor deployment planning, user participation, and spatial anchor improvement information.

In a metaverse in which a virtual space and a real space are mixed, a spatial anchor of a location-based spatial map service may serve as a fixed point in a real world capable of connecting virtual content and being maintained across multiple user sessions. By using the spatial anchor, a user may place a virtual object at a specific location and may return to the location later, or the virtual object may reappear at the same location even when multiple users are located in the same space.

The spatial anchor may provide the following characteristics.

Persistence: A method for storing and retrieving a location and a direction of virtual content in a real world may be provided.

Shared Reference: A shared reference frame may be provided such that users may view virtual content at the same location on different devices.

Persistence across Sessions: It may be ensured that virtual content is maintained at the same location and in the same direction even when a user later returns to the corresponding location or closes and reopens an application.

Information to be included and managed in a spatial map as spatial map information may include a spatial map ID, a three-dimensional space defined in the spatial map, access control rules, and object and attribute information within a corresponding region.

Processed sensor data may be sensing result information for a spatial mapping service. The sensing result information may be particularly for object (stationary and moving) modeling and tracking, and may include estimation regarding the number of objects, object types, positions, directions, velocities, and so on.

A spatial map generation procedure may be specified or performed by a spatial map server or a VAL server. A method by which the spatial map server obtains sensor data or processed sensing result information from an authorized user equipment (UE) or a third-party provider may be defined in a normative stage.

According to exemplary embodiments of the present disclosure, a spatial map management server may generate multiple spatial maps for a physical 3D space of a given area of interest. The spatial maps may be generated to include one or more overlapped 3D spaces. Each spatial map may include objects identified by sensing within a dimension of the spatial map, which is a 3D space defining the corresponding spatial map. The spatial map management server may identify physical objects existing within the dimension of the spatial map by using sensing information and may manage information regarding an identifier, a location, a shape, a characteristic, and so on, of each identified object. In addition, a plurality of spatial anchors may be defined by a spatial anchor management server within the given area of interest. Since multiple spatial maps may overlap and exist for the physical 3D space of the given area of interest, the objects and the spatial anchors may commonly belong to one or more of the spatial maps. Identifiers for the objects are uniquely assigned within a spatial map server, and identifiers for the spatial anchors are uniquely assigned within a spatial anchor server, thereby making it possible to easily manage a correlation among multiple spatial maps, objects, and spatial anchors.

FIG. 2 is a diagram illustrating a functional model for an On-network Spatial Anchors service according to an exemplary embodiment of the present disclosure.

The term “metaverse” may have been used in various ways in order to indicate a broader meaning of AR and VR. The term may be used to indicate a set of spaces perceived as being persistent, shared, and interactable. “Metaverse” may evoke a concept including new experiences, products, and services capable of appearing in virtual reality and augmented reality services in various industrial fields.

Localized mobile metaverse services may be immersive and may be integrated into an ordinary experience of a user. Such a service experience may be related to a location and may include provision of AR and MR media. The localized mobile metaverse services may be associated with a specific place (a three-dimensional location in a physical world). An association between such a place and service information may be referred to as a spatial anchor. A spatial anchor may allow a mobile metaverse service to be discovered and accessed when a user is authorized. Localization of a user may be important in order to discover a spatial anchor.

A spatial map may be generated by using processed sensor data. Generation of a spatial map for a specific location may enable localization at the corresponding location and may also enable assignment of a spatial anchor at the corresponding location.

Exemplary embodiments of the present disclosure may provide an application layer architecture and related procedures for enabling spatial anchors management and spatial mapping management.

As shown in FIG. 2, functional entities of a Spatial Anchors service may be grouped into a vertical application layer and a Service Enabler Architecture Layer (SEAL) layer. The Spatial Anchors service may provide functions for managing spatial anchors with respect to the vertical application layer. Such a Spatial Anchors service functional model may be based on a SEAL layer defined in 3GPP TS 23.434.

A Spatial Anchor client (SAn client) and a Spatial Anchor server (SAn server) may respectively constitute Spatial Anchors service functional entities within a user equipment (UE) and a network.

A VAL client and a VAL server may be an application client and an application server for providing an application service to a user.

The SAn client and the SAn server may respectively provide a client-side function and a server-side function for performing spatial anchor management for an application.

The SAn client is a SEAL client providing a spatial anchor service to the VAL client, and the SAn server may be a SEAL server providing a spatial anchor service to the VAL server and the UE.

An interface between the SAn client and the SAn server is SAn-UU, the SAn client may interact with the VAL client through an SAn-C interface, and the SAn server may interact with the VAL server through an SAn-S interface.

In addition, the SAn server may communicate with a 3GPP network system directly or through a Network Exposure Function (NEF), and may communicate by using a network interface (e.g., T8, N33) defined by the 3GPP network system.

When the SAn server is deployed by a PLMN operator, the SAn server may communicate with the 3GPP network system by directly invoking an API exposed by a 3GPP core network function.

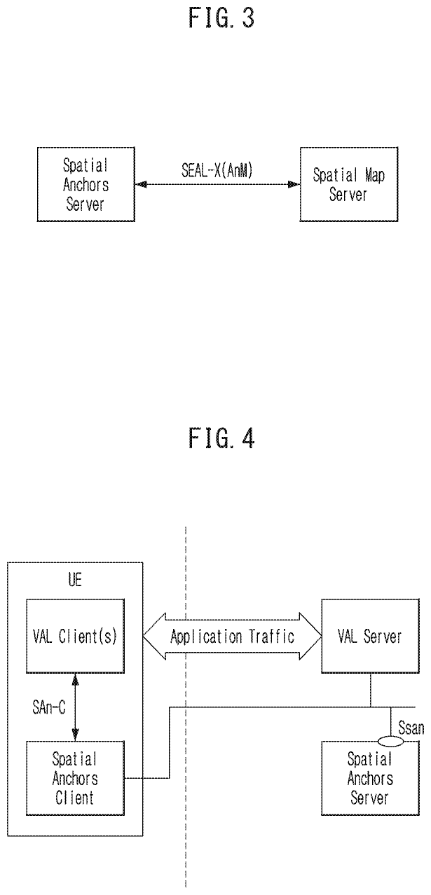

FIG. 3 is a diagram illustrating an interaction between a spatial anchor management server and a spatial map management server according to an exemplary embodiment of the present disclosure.

As shown in FIG. 3, a Spatial Anchor server (SAn server) may be interconnected with a Spatial Map server (SM server) through a SEAL-X(AnM) reference point.

The SEAL-X(AnM) reference point is an interface between the Spatial Anchor server and the Spatial Map server and may provide a function for exchanging spatial map information and object-related information.

The Spatial Anchor server may obtain spatial map information or object-related information from the Spatial Map server, and such information may be utilized in a process of generation/creation, discovery, or subscription processing of a spatial anchor.

In particular, the Spatial Anchor server may manage a spatial anchor based on information such as a position, localization information, an object identifier, and so on, of an object through an interaction with the Spatial Map server.

FIG. 4 is a diagram illustrating a service based architecture for a Spatial Anchors service according to an exemplary embodiment of the present disclosure.

In the service based architecture, a Spatial Anchor server may interact with a VAL server and a Spatial Anchor client in order to process application traffic.

The VAL server or the Spatial Anchor client may transmit a service request to the Spatial Anchor server, and the Spatial Anchor server may process the corresponding request and then provide a response.

In such a structure, the Spatial Anchor server is a service providing entity operating in a SEAL layer and may provide a spatial anchor management function through a service based interface.

In addition, the Spatial Anchor server may perform an intermediary function between an application layer and a network layer and may process a spatial anchor-related service request and generate a response based on application traffic.

In exemplary embodiments of the present disclosure, a spatial anchor profile may be represented as shown in Table 1 below.

TABLE 1

| Information element | Status | Description |
|---|---|---|
| Spatial anchor ID | M | Identifier of the discovered spatial anchor. |
| Position (NOTE 1) | O | The 3D geographic position of the spatial anchor in |
| | | space (x, y and z coordinates). |
| Spatial map position | O | Position information based on spatial map. It |
| (NOTE 1) | | includes the identifier of the Spatial map and the |
| | | corresponding localization information or object ID. |
| > Spatial map ID | O | Identifier of the spatial map |
| >> Spatial map layer ID | O | Identifier of the spatial map layer if Spatial map ID |
| | | is present |
| >> Localization | O | 3D position and pose of the VAL UE |
| (NOTE 2) | | |
| >> Object ID (NOTE 2) | | Identifier of the object on which the spatial anchor |
| | | is produced. The object can be stationary or |
| | | trackable. |
| Application specific | O | A container to contain application specific |
| Spatial anchor | | information. |
| information | | |
| VAL service information | M | Information about the application service |
| | | associated with the spatial anchor. |
| > VAL Service ID | M | The identifier of the application service. |
| > Service endpoint | M | Endpoint information (e.g., URI, FQDN, IP |
| | | address) used to communicate with the application |
| | | service. |
| > Service connection | O | The connection information (e.g., DNN, DNAI(s)) |
| information | | for establishing connectivity to the application |
| | | service. |
| Service area | O | The service area where the spatial anchor is |
| | | accessible. |
| Allowed entities list | O | Identity of entities (e.g. VAL client, VAL server or |
| | | VAL service identity) which are permitted to |
| | | discover the spatial anchor. |
| >Spatial anchor group | O | Identifier of spatial anchor group that the spatial |
| ID | | anchor associates with |
| Time period | O | Indicates time period or duration or time windows - |
| | | comprising a start time and an expiry time. A |
| | | spatial anchor is active during this time period. |
| | | After the expiry time, the state of a spatial anchor |
| | | becomes inactive. The time period may include |
| | | one or more values (e.g. repeated over time/day). |
| Expiry handling | O | Indicates whether the spatial anchor has to be |
| indication | | deleted or its state to be updated as inactive on |
| | | expiry by the SAn server. Absence of this IE shall |
| | | be considered that SAn server deletes the spatial |
| | | anchor on expiry. |
| Spatial anchor state | O | Indicates the state of the spatial anchor (active or |
| | | inactive). Spatial anchors in inactive state is not |
| | | discoverable.Absence of this IE shall be |
| | | considered as spatial anchor is in active state. |

NOTE 1:
One of the IEs shall be present.
NOTE 2:
If Spatial map ID is present, either one of the IEs shall be present.

In exemplary embodiments of the present disclosure, spatial map information may be represented as shown in Table 2 below.

TABLE 2

| Information | | |
|---|---|---|
| element | Status | Description |
| Spatial map ID | M | The identifier of the spatial map |
| Spatial map | M | The three-dimensional space coordinates |
| coverage | | information of the spatial map |
| Allowed entities | O | Identity of entities (e.g. VAL client, VAL server or |
| list | | VAL service identity) which are permitted to |
| | | discover and access the spatial map |
| Spatial map | O | The media format of the spatial map. |
| media format | | |
| List of spatial map | M | The list of spatial map layer information. At least |
| layers | | one or more spatial map layers should be included. |
| | | Each element includes the information described |
| | | below. |
| > Spatial map | M | The identifier of the corresponding spatial map |
| layer ID | | layer. |
| > Spatial map | O | A container to carry the corresponding spatial map |
| layer information | | layer specific information |
| >> area | O | The area covered by this layer. This area can be |
| | | the same or a subset of the Spatial map coverage |
| | | space. |
| >> associated | O | The details about a spatial map associated with |
| spatial map | | this layer. For example, if the layer is for a |
| | | particular floor of the building, the detailed spatial |
| | | map of that particular floor can be associated with |
| | | this layer. |
| > List of objects | O | List of object information. Each element contains |
| | | the information as specified in Table 7.3.3.1-2. |

In exemplary embodiments of the present disclosure, spatial map object information may be represented as shown in Table 3 below.

TABLE 3

| Information | | |
|---|---|---|
| element | Status | Description |
| Object ID | M | The identifier of the corresponding object |
| Object type | M | The type of object |
| | | (for example, indicating stationary object or |
| | | moving/trackable object) |
| Associated UE | O | Identifier of the UE associated with the |
| ID | | object. |
| Object mobility | M | Classifies whether the object is stationary or |
| information | | trackable. |
| > Object | O | The 3D position of the object in the layer. For |
| position | | stationary object, this IE shall be present. For |
| | | trackable object, 3D position of it shall be |
| | | provided while it is being tracked, otherwise |
| | | no value. |
| > Direction | O | Direction of the trackable object while it's |
| (NOTE) | | being tracked, otherwise no value. |
| > Velocity | O | Velocity of the trackable object while it's |
| (NOTE) | | being tracked, otherwise no value. |
| Object specific | O | Object specific attribute information |
| information | | |

NOTE:
These IEs may be present when object is moving or changes it's location frequently.

M of Status may indicate Mandatory, and O of Status may indicate Optional.

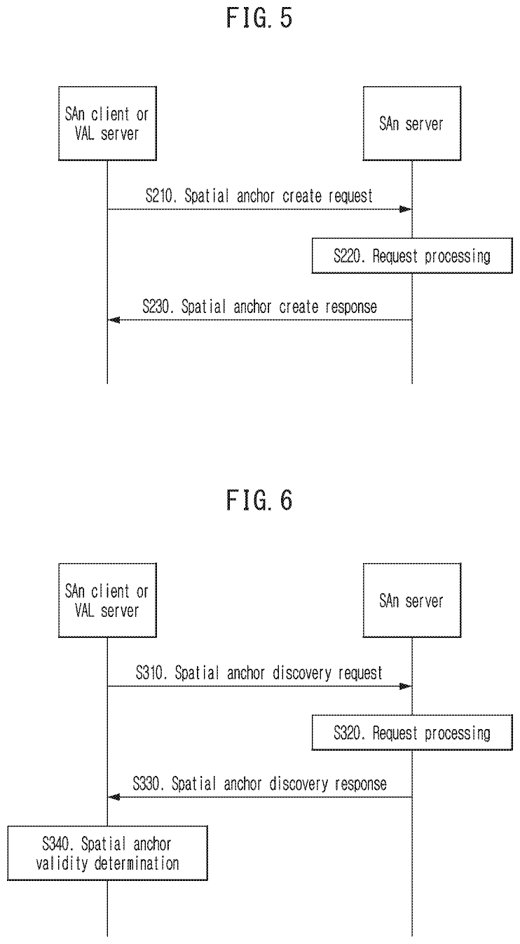

FIG. 5 is a diagram illustrating a spatial anchor generation/creation procedure according to an exemplary embodiment of the present disclosure.

As shown in FIG. 5, according to an exemplary embodiment of the present disclosure, a method performed by a spatial anchor management server may include receiving a request for creating/generating a spatial anchor associated with an object in a spatial map, the request including spatial map information (S210); and creating/generating the spatial anchor associated with the object based on the spatial map information (S220). The spatial map information may include a spatial map identifier identifying the spatial map and an object identifier identifying the object included in the spatial map.

In the method according to exemplary embodiments of the present disclosure, in creating/generating the spatial anchor (S220), the spatial anchor may be created based on spatial map position information including one or more of the spatial map identifier; a spatial map layer identifier and localization information corresponding to the spatial map layer identifier; or the object identifier.

In the method according to exemplary embodiments of the present disclosure, the localization information may include a three-dimensional (3D) position and a pose of the object.

By spatial anchor creation/generation, an SAn client or a VAL server may create one or more spatial anchors by using an SAn server.

As a pre-condition for performing this procedure, the SAn client or the VAL server may receive information regarding the SAn server (e.g., URI, IP address, and so on). In addition, the SAn client or the VAL server may receive security credentials for communicating with the SAn server. When the SAn client triggers this procedure, the SAn client may receive necessary information from a VAL client through an SAn-C reference point.

A spatial anchor creation/generation procedure may be performed as follows.

A requestor (e.g., an SAn client or a VAL server) may transmit a spatial anchor creation request to an SAn server (S210).

The spatial anchor creation request may include a requestor identifier, security credentials, and a list of spatial anchors to be created.

The spatial anchor creation request may include a position of a spatial anchor, an allowed entities list defining an entity capable of discovering or accessing the corresponding spatial anchor, and discoverability information indicating whether the spatial anchor is discoverable by an arbitrary user.

The requestor may intend to associate the spatial anchor with a stationary object or a trackable object within a spatial map. In such a case, the request may include a spatial map position, which may include a corresponding spatial map ID and object ID.

When the request includes application specific spatial anchor information, the corresponding information may be maintained opaque with respect to the SAn server and may be stored together with the spatial anchor.

The request may indicate creation of a plurality of spatial anchors. A request message may include a spatial anchor group ID assigned by the requestor for each spatial anchor, when the corresponding ID exists. When the spatial anchor group ID does not exist, the SAn server may create a spatial anchor group and may associate the corresponding spatial anchors with the group.

The application specific spatial anchor information is not construed as being limited to a specific exemplary embodiment of the present disclosure. For example, the application specific spatial anchor information may include a URL, media data, a type, a manufacturer, a date, a rating, customer premises information (e.g., a residence, an office, a store, and so on). Such information may be stored as a key-value pair and may be maintained opaque with respect to the SAn server.

Upon receiving the request, the SAn server may validate whether the requestor is authorized to perform the request. When the requestor is authorized, the SAn server may create a spatial anchor (S220).

When the request is for creating a spatial anchor on an object, the SAn server may create the spatial anchor by using spatial map position information included in the request.

The SAn server may assign a spatial anchor identifier to the created spatial anchor and may store corresponding spatial anchor information.

The SAn server may transmit a spatial anchor creation response to the requestor (S230).

When the SAn server successfully creates the spatial anchor, the response may include identifiers of newly created spatial anchors together with information indicating whether creation is successful.

Otherwise, the response may include a reason for failure together with information indicating whether creation fails.

In exemplary embodiments of the present disclosure, information elements (IEs) included in a spatial anchor creation request may be represented as shown in Table 4 below.

TABLE 4

| Information element | Status | Description |
|---|---|---|
| Requestor identifier | M | The identifier of the requestor (e.g., VAL |
| | | server or VAL UE and VAL user). |
| Security credentials | M | The security credentials of the requestor. |
| VAL service information | M | Information about the application service |
| | | associated with the spatial anchor. |
| > Service ID | M | The identifier of the application service. |
| > Service endpoint | M | Endpoint information (e.g., URI, FQDN, IP |
| | | address) used to communicate with the |
| | | application service. |
| > Service connection | O | The connection information (e.g., DNN, |
| information | | DNAI(s)) for establishing connectivity to |
| | | the application service. |
| List of spatial anchors | M | List of spatial anchors to be created. |
| > Position information | M | Position information of the spatial anchor |
| >> Position (NOTE 1) | O | The 3D geographic position of the spatial |
| | | anchor in space (x, y and z coordinates). |
| > Spatial map position | | Position information of the spatial anchor |
| (NOTE 1) | | within the spatial map. It includes the |
| | | identifier of the Spatial map, identifier of |
| | | spatial map layer(s) and the corresponding |
| | | localization information (The localization |
| | | information is specific to spatial map |
| | | format) or object ID. |
| >>> Spatial map ID | O | Identifier of the spatial map |
| >>>> Spatial map layer ID | O | Identifier of the spatial map layer if Spatial |
| | | map ID is present |
| >>>> Localization | O | 3D position and pose of the VAL UE |
| (NOTE 2) | | |
| >>>> Object ID (NOTE 2) | | Identifier of the object on which the spatial |
| | | anchor will be created |
| > Application specific | O | A container to contain application specific |
| Spatial anchor information | | information. |
| > Service area | O | The service area where the spatial anchor |
| | | is accessible. |
| > Allowed entities list | O | Identity of entities (e.g. VAL client, VAL |
| | | server or VAL service identity) which are |
| | | permitted to discover the spatial anchor. |
| > Associated name | O | Name of the product/service associated |
| | | with the spatial anchor |
| > Time period | O | Indicates time period or duration or time |
| | | windows - comprising a start time and an |
| | | expiry time. A spatial anchor is active |
| | | during this time period. After the expiry |
| | | time, the state of a spatial anchor becomes |
| | | inactive. The time period may include one |
| | | or more values (e.g. repeated over |
| | | time/day). |
| > Expiry handling indication | O | Indicates whether the spatial anchor has to |
| | | be deleted or its state to be updated as |
| | | inactive on expiry by the SAn server. |
| | | Absence of this IE shall be considered that |
| | | SAn server deletes the spatial anchor on |
| | | expiry. |
| > Spatial anchor resource | M | The identifier to associate the resource |
| identifier | | information with the created spatial |
| | | anchors. |
| > Spatial anchor group ID | O | Identifier of spatial anchor group that the |
| | | spatial anchor associates with |

NOTE 1:
One of the IEs shall be present.
NOTE 2:
If Spatial map ID is present, either one of the IEs shall be present.

In exemplary embodiments of the present disclosure, information elements (IEs) included in a spatial anchor creation response may be represented as shown in Table 5 below.

TABLE 5

| Information element | Status | Description |
|---|---|---|
| Successful response | O | Indicates that the spatial anchor create |
| | | request was successful. |
| > List of spatial anchors | O | The list of created spatial anchors. |
| >> Spatial anchor ID | O | The identifier of the spatial anchor |
| >> Spatial anchor resource | O | The identifier provided by the SAn client in |
| identifier | | order to associate the created spatial |
| | | anchor with the resource information used |
| | | for creating the spatial anchor. |
| >> Spatial anchor group ID | O | Identifier of spatial anchor group being |
| | | associated with this spatial anchor. |
| Failure response | O | Indicates that the create spatial anchor |
| | | request has failed. |
| > Cause | O | The cause for the request failure. |

FIG. 6 is a diagram illustrating a spatial anchor discovery procedure according to an exemplary embodiment of the present disclosure.

As shown in FIG. 6, according to an exemplary embodiment of the present disclosure, a method may further include receiving a request for discovering a spatial anchor of interest, the request including a request identifier and a spatial anchor discovery filter (S310); and transmitting a response for discovering the spatial anchor of interest (S330). The response for discovering the spatial anchor of interest may include one or more of position information of the spatial anchor of interest in a three-dimensional space; or spatial map position information including a spatial map corresponding to the spatial anchor of interest.

The method according to exemplary embodiments of the present disclosure may further include validating the request for discovering the spatial anchor of interest based on security credentials of a requestor included in the request for discovering the spatial anchor of interest and the request identifier. Validating the request for discovering the spatial anchor of interest may be performed as a part of processing the request (S320) or may be performed before operation S320.

In the method according to exemplary embodiments of the present disclosure, the spatial anchor discovery filter may include one or more of an identifier of the spatial anchor of interest; an area of interest; a service identifier identifying a vertical application layer (VAL) service; an associated name associated with the spatial anchor of interest; or application specific spatial anchor information.

In the method according to exemplary embodiments of the present disclosure, the spatial map position information included in the response for discovering the spatial anchor of interest may include one or more of a spatial map identifier identifying a spatial map corresponding to the spatial anchor of interest; a spatial map layer identifier identifying a layer included in the spatial map corresponding to the spatial anchor of interest and including the spatial anchor of interest; or an object identifier identifying an object associated with the spatial anchor of interest and included in the spatial map corresponding to the spatial anchor of interest.

The method according to exemplary embodiments of the present disclosure may further include, in association with operation S320, obtaining current position information of a movable and trackable object from a spatial map management server when the spatial anchor of interest is associated with the movable and trackable object. The response for discovering the spatial anchor of interest may further include spatial map position information including the current position information of the movable and trackable object.

By spatial anchor discovery, an SAn client or a VAL server may discover one or more spatial anchors by using an SAn server. Discovery of a spatial anchor may be based on identification of a spatial anchor matching a spatial anchor discovery filter included in a corresponding request.

A spatial anchor discovery procedure may be performed according to a request-response model.

As pre-conditions for performing this procedure, the SAn client or the VAL server may receive information (e.g., URI, IP address, and so on) related to the SAn server, and may receive security credentials for communicating with the SAn server. In addition, when the SAn client triggers the procedure, the SAn client may receive required information from a VAL client over an SAn-C interface.

A spatial anchor discovery procedure may be performed as follows.

A requestor (e.g., SAn client or VAL server) may send a spatial anchor discovery request message to the SAn server to obtain information about a spatial anchor of interest.

The request may include a requestor identifier and security credentials, and may further include a spatial anchor discovery filter.

When the discovery request is triggered by a VAL client on a UE, the spatial anchor discovery request may additionally include a VAL client identifier and a location of the client.

The following operations may be performed as a part of operation S320 or may be performed before or after operation S320.

Upon receiving the request, the SAn server may validate whether the requestor is authorized for the corresponding request. When the requestor is authorized, the SAn server may identify one or more spatial anchors satisfying the spatial anchor discovery filter included in the request.

When an “area of interest” discovery filter is specified in the discovery request, for a spatial anchor on a stationary object, the SAn server may find a three-dimensional position of the object from corresponding spatial map information.

For a spatial anchor associated with a trackable object, the SAn server may obtain current position information of the corresponding object at a time of discovery from a SEAL SM server through a SEAL-X(AnM) reference point.

The SAn server may consider a period during which tracking of the corresponding object within the spatial map is expected to be maintained, and this information may be obtained from the SM server.

The SAn server may consider an estimated duration of tracking of the corresponding object within the spatial map, and this information may be obtained from the SM server.

The SAn server may determine a spatial anchor included in an area of interest by using such information.

The SAn server may send a response for discovering the spatial anchor of interest to the requestor (S330).

When the SAn server identifies the spatial anchor, the response may include information indicating whether discovery is successful and may include an identified spatial anchor and a recommended list of spatial anchors.

In operation S320, when processing the discovery request, the SAn server may not include the spatial anchor in the response for discovering the spatial anchor of interest when a state of the spatial anchor is inactive.

When the SAn server fails to identify the spatial anchor, the response may include a reason for failure together with information indicating whether discovery fails.

A logic to generate the recommended list of spatial anchors by the SAn server is not construed as being limited by a specific exemplary embodiment.

The response for discovery may include a list of discovered spatial anchors sorted starting with a spatial anchor closest to a location of a requestor (client).

Upon receiving the response for spatial anchor discovery, when the response indicates success, the requestor may store spatial anchor information in a spatial anchor cache. The requestor may evaluate a validity condition associated with the discovered spatial anchor before using the spatial anchor (S340). When the requestor is an SAn client, the SAn client may provide the spatial anchor information to VAL client(s). Upon receiving valid spatial anchor information, the VAL client(s) may access service(s) associated with each spatial anchor.

In exemplary embodiments of the present disclosure, information elements (IEs) included in a spatial anchor discovery request may be represented as shown in Table 6 below.

TABLE 6

| Information element | Status | Description |
|---|---|---|
| Requestor identifier | M | The identifier of the requestor (e.g., |
| | | VAL server or VAL UE and VAL user). |
| Security credentials | M | The security credentials of the requestor. |
| VAL client ID | O | The identifier of the VAL client when the |
| | | requestor is a SAn client. |
| Location | O | Indicates the location information of the |
| information | | VAL client when the requestor is a SAn |
| | | client. |
| Discovery filters | O | The filters used for determining the spatial |
| | | anchors. |
| > List of spatial | O | The list of spatial anchor identifiers to |
| anchor ID | | discover. |
| > Area of interest | O | The area of interest (e.g., topological area |
| | | and/or geographical area). |
| > Service ID | O | The identifier of a VAL service. |
| > Associated name | O | Name of the product/service associated |
| | | with the spatial anchor |
| > Application | | A container to contain application specific |
| specific Spatial | | information. |
| anchor information | | |

In exemplary embodiments of the present disclosure, information elements (IEs) included in a response for spatial anchor discovery may be represented as shown in Table 7 below.

TABLE 7

| Information element | Status | Description |
|---|---|---|
| Successful response | O | Indicates that the spatial anchor discovery |
| | | request was successful. |
| List of spatial anchors | O | List of discovered spatial anchors. |
| > Spatial anchor ID | M | Identifier of the discovered spatial anchor. |
| > Position (NOTE) | O | The 3D position of the spatial anchor in |
| | | space (x, y and z coordinates). |
| > Spatial map position | O | Position information based on spatial map. |
| (NOTE) | | It includes the identifier of the Spatial map, |
| | | spatial map layer ID and object ID. |
| >> Spatial map ID | O | Identifier of the corresponding spatial map. |
| | | This IE shall be present if Spatial map ID |
| | | is present. |
| >> Spatial map layer ID | O | Identifier of the spatial map layer which |
| | | includes the spatial anchor object. This IE |
| | | shall be present if Spatial map ID is |
| | | present. |
| >> Object ID | O | Identifier of the object on which spatial |
| | | anchor is produced. This IE shall be |
| | | present if Spatial map ID is present. |
| > Associated name | O | Name of the product/service associated |
| | | with the spatial anchor |
| > Time period | O | Indicates time period or duration or time |
| | | windows - comprising a start time and an |
| | | expiry time. A spatial anchor is active |
| | | during this time period. After the expiry |
| | | time, the state of a spatial anchor becomes |
| | | inactive. The time period may include one |
| | | or more values (e.g. repeated over |
| | | time/day). |
| > Application specific | O | A container to contain application specific |
| Spatial anchor information | | information. |
| > VAL service information | M | Information about the application service |
| | | associated with the spatial anchor. |
| >> Service ID | M | The identifier of the application service. |
| >> Service endpoint | M | Endpoint information (e.g., URI, FQDN, IP |
| | | address) used to communicate with the |
| | | application service. |
| >> Service connection | O | The connection information (e.g., DNN, |
| information | | DNAI(s)) for establishing connectivity to |
| | | the application service. |
| Failure response | O | Indicates that the spatial anchor discovery |
| | | request has failed. |
| > Cause | O | The cause for the request failure. |

NOTE:
Either one of the IEs shall be present.

As shown in Table 7, information elements (IEs) included in a response for spatial anchor discovery may be as follows.

Successful response: Information indicating that a spatial anchor discovery request succeeds may be included.

List of spatial anchors: A list of discovered spatial anchors may be included.

Spatial anchor ID: An identifier of a discovered spatial anchor may be included.

Position: A three-dimensional position (x, y, z coordinates) of a spatial anchor within a space may be included.

Spatial map position: Position information based on a spatial map may be included, and the position information may include a spatial map identifier, a spatial map layer ID, and an object ID.

Spatial map ID: A corresponding spatial map may be identified.

Spatial map layer ID: A spatial map layer including a spatial anchor object may be identified.

Object ID: An object on which a spatial anchor is generated may be identified.

Associated name: A name of a product or a service associated with a spatial anchor may be included.

Time period: A time period including a start time and an expiration time may be indicated, and the spatial anchor may be in an active state during the corresponding period. After the expiration time, a state of the spatial anchor may become an inactive state.

Application specific spatial anchor information: A container including application specific information may be included.

VAL service information: Information regarding an application service associated with a spatial anchor may be included.

Service ID: An application service may be identified.

Service endpoint: Communication information such as a URI, an FQDN, an IP address, and so on, may be included.

Service connection information: Information such as DNN, DNAI, and so on, for establishing a connection with an application service may be included.

Failure response: Information indicating that the spatial anchor discovery request fails may be included, and a cause for failure may be included.

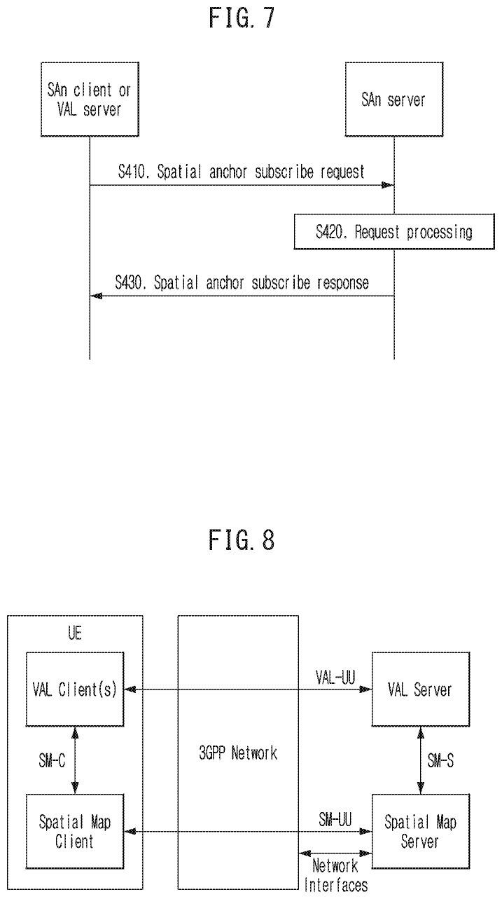

FIG. 7 is a diagram illustrating a spatial anchor subscription procedure according to an exemplary embodiment of the present disclosure.

As shown in FIG. 7, according to an exemplary embodiment of the present disclosure, a method may include receiving a request for subscribing to a spatial anchor of interest, the request including a spatial anchor filter including an area of interest (S410); and obtaining current position information of a movable and trackable object from a spatial map management server when the spatial anchor of interest is associated with the movable and trackable object (S420). Whether the spatial anchor of interest exists within the area of interest may be determined based on the current position information. In addition, a response to the request for subscribing transmitted in operation S430 may include information associated with the spatial anchor of interest based on the current position information.

The method according to exemplary embodiments of the present disclosure may further include, in association with operation S420, monitoring a location of a user equipment (UE) and a position of the movable and trackable object; and determining whether the spatial anchor of interest is in-range or out-of-range with respect to the UE based on the current position information of the movable and trackable object and mobility prediction information obtained from the spatial map management server.

By spatial anchor subscription, an SAn client or a VAL server may establish a subscription with an SAn server and may receive a notification related to a spatial anchor.

As pre-conditions for performing this procedure, the SAn client or the VAL server may receive information (e.g., URI, IP address) related to the SAn server. In addition, the SAn client or the VAL server may receive security credentials authorizing communication with the SAn server.

A requestor (e.g., SAn client or VAL server) may send a spatial anchor subscription request to an SAn server (S410). The request may include a requestor identifier, security credentials, a notification endpoint, and event information to which the requestor intends to subscribe. The request may include an expiration time.

The requestor may include a “discovery” event type to indicate that the SAn server is to notify the requestor when the SAn server detects an event related to management of a spatial anchor (e.g., generation/creation, update, deletion, or a spatial anchor state change (e.g., active, inactive, expired)) according to a discovery event filter and a spatial anchor filter provided in the request. When the requestor is an SAn client, the request may include a VAL client identifier.

The VAL server may include a “UE with spatial anchor interest” event type to indicate that the SAn server is to notify the VAL server when the SAn server detects UE(s) having an interest in specific spatial anchors according to an interest spatial anchor event filter and a spatial anchor filter provided in the request.

The requestor may include a “spatial anchor in range” event type in order to indicate that the SAn server is to notify the requestor when the SAn server detects that spatial anchors become in-range of a subscriber or become out-of-range of the subscriber according to range event filters provided in the request. The range event filters may include a range for detecting spatial anchors, an indication for enabling persistent search, and a pose of the subscriber. When the requestor is an SAn client, the spatial anchor subscription request may include a VAL client identifier.

The following operations may be performed as a part of operation S420 or may be performed before or after operation S420.

Upon receiving the request from the requestor, the SAn server may validate whether the requestor is authorized for the request. When the requestor is authorized, the SAn server may create a subscription and may store subscription information.

When the subscribed event is for “discovery,” the SAn server may start monitoring of a spatial anchor management event according to the discovery event filter and the spatial anchor filter.

When the subscribed event is for “UE with spatial anchor interest,” the SAn server may start monitoring of spatial anchors of interest according to the UE with spatial anchor interest event filter and the spatial anchor filter. When the spatial anchors of interest are discovered by a UE, the SAn server may obtain UE location information from a 5GS or a SEAL Location Management service. In addition, the SAn server may consider data analytics such as UE mobility prediction. The SAn server may monitor a distance between UEs and the spatial anchors of interest to determine whether the UEs enter, exit, or is within a range of the spatial anchors of interest.

When the subscribed event is for “spatial anchor in range” and the requestor is an SAn client, the SAn server may start monitoring of a corresponding UE location and direction corresponding to pose information according to the range event filter and the spatial anchor filter. UE location information may be obtained by using capabilities of a 5GS or a SEAL Location Management service.

The SAn server may consider data analytics such as UE mobility prediction. The SAn server may monitor a distance between UEs and the spatial anchors of interest to determine whether the spatial anchors become in-range of the UE or become out-of-range of the UE.

When persistent search is enabled, the SAn server may monitor a location of a user (or a location of a UE) and a pose of the user along a movement direction to discover a list of spatial anchors becoming in-range of the user equipment or becoming out-of-range of the user equipment, based on a location of the user device, a pose of the user, and a movement direction of the user.

For a spatial anchor associated with a trackable object, the SAn server may determine whether a UE is in-range or out-of-range by using a current position of an object being tracked by a SEAL SM server.

In addition, the SAn server may consider mobility prediction of the trackable object based on data analytics for a position, a direction, and a velocity of the object.

A method for performing mobility prediction of the trackable object and a method for estimating a duration of object tracking in an in-range state may vary depending on exemplary embodiments.

The SAn server may send a spatial anchor subscription response to the requestor (S430). When the SAn server creates the subscription, the response may include a success indication, a subscription identifier, and an expiration time. In order to maintain the subscription, the requestor may be required to send a subscription update request before the expiration time, otherwise the spatial anchor subscription may expire. When the SAn server fails to create the subscription, the response may include a failure indication and may include a reason for failure.

FIG. 8 is a diagram illustrating a functional model for an On-network Spatial Map service according to an exemplary embodiment of the present disclosure.

As shown in FIG. 8, a Spatial Map (SM) management service may be a SEAL service providing spatial map related capabilities to vertical application(s).

A functional model for a spatial map server of FIG. 8 may include functional entities in order to describe a functional architecture which addresses support for a spatial map aspect for vertical applications.

Spatial map management functional entities may be grouped into a vertical application layer and a Service Enabler Architecture Layer (SEAL) layer. Spatial map management may offer capabilities to manage a spatial map to the vertical application layer. A spatial map management functional model may be based on the SEAL layer specified in 3GPP TS 23.434 [4].

Spatial map functional entities in a UE and a network may be a spatial map (SM) client and a spatial map (SM) server, respectively. A VAL client and a VAL server may be an application client and a server to provide an application service to a user. The SM client and the SM server may provide a client-side functionality and a server-side functionality for managing a spatial map for an application, respectively. The SM client may be a SEAL client providing a spatial map service to the VAL client. The SM server may be a SEAL server providing a spatial map service to the VAL server and the UE. An interface between the SM client and the SM server may be SM-UU. The SM client may interact with the VAL client by using an SM-C interface. The SM server may interact with the VAL server by using SM-S. The SM server may communicate with an underlying 3GPP network system directly or via NEF by using 3GPP interfaces specified by the 3GPP network system (e.g., T8, N33). When the SM server is deployed by a PLMN operator, the SM server may communicate with the 3GPP network system by directly invoking APIs exposed by 3GPP core network functions.

The SM server may interact with the SAn server over a SEAL-X(AnM) reference point.

The SM server may operate as a SEAL server, may be used to provide services for generation/creation, update, deletion, and discovery of a spatial map for a VAL application, that is, a metaverse application, and may also provide a spatial localization service.

In alternative exemplary embodiments of the present disclosure, the SM server may be implemented by a distributed SEAL deployment and may communicate with another SM server in the distributed SEAL deployment for processing of a request disclosed in exemplary embodiments of the present disclosure.

The SM client may act as a SEAL client for a spatial map function. The SM client may support client-side functionalities for generation/creation, update, deletion, discovery, and retrieval of a spatial map for a VAL application, that is, a metaverse application, and may also provide a spatial localization service. The SM client may receive a request from the VAL client to perform a specific functionality.

The VAL server may be specified in clause 6.4.2.3 of 3GPP TS 23.434 [4]. The VAL server may provide server-side functions corresponding to vertical applications, that is, metaverse applications, to a client of a VAL user based on a service contract.

The VAL client may be specified in clause 6.4.2.2 of 3GPP TS 23.434 [4]. The VAL client may provide metaverse services to a user. The VAL client may use the SM client to manage spatial maps for an application.

The SM-UU reference point may enable interaction between the SM client and the SM server. The SM-UU reference point may be used for generation/creation, update, deletion, discovery, and retrieval of a spatial map for VAL applications, that is, metaverse applications.

The SM-S reference point may enable interaction between the SM server and VAL servers, that is, metaverse application servers. The SM-S reference point may be used for generation/creation, update, deletion, obtainment, and retrieval of a spatial map for VAL applications, that is, metaverse applications.

The SM-C reference point may enable interaction between the SM client and VAL clients, that is, metaverse application clients. The SM-C reference point may be used by the VAL client to share information regarding spatial map related information with the SM client and also to obtain spatial map related information from the SM client.

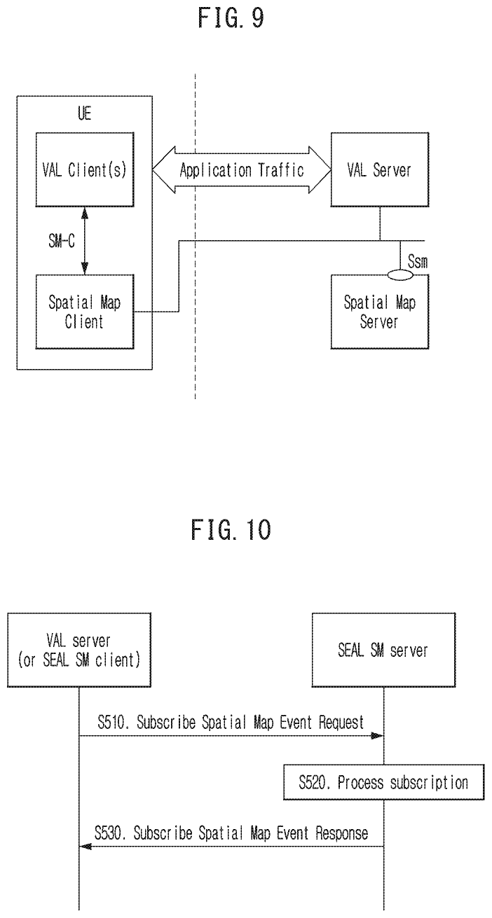

FIG. 9 is a diagram illustrating a service based architecture for a Spatial Map service according to an exemplary embodiment of the present disclosure.

As shown in FIG. 9, the SM server may expose/provide APIs over an Ssm interface to the VAL server and the SM client. VAL servers may consume services by interacting on the Ssm interface of the SM server. A Common API Framework (CAPIF) may be used by VAL functions for discovery of services of the SM server.

Application Traffic may be exchanged between the VAL client and the VAL server.

FIG. 10 is a diagram illustrating a Spatial Map event subscription procedure according to an exemplary embodiment of the present disclosure.

As shown in FIG. 10, a method performed by a spatial map management server according to another exemplary embodiment of the present disclosure may include receiving a request for subscribing to a spatial map event, the request including a spatial map identifier identifying a spatial map and event information (S510); and transmitting a response to the request for subscribing to the spatial map event (S530). The response may include one or more of a subscription identifier based on a successful validation of the spatial map event subscription request; or a failure indication and a reason for failure for validation of the spatial map event subscription request.

The following operations may be performed as a part of operation S520 or may be performed before or after operation S520.

The method according to exemplary embodiments of the present disclosure may further include authorizing a requestor based on security credentials and a requestor identifier of the requestor included in the spatial map event subscription request; and validating the spatial map event subscription request based on an authorization result of the requestor.

In the method according to exemplary embodiments of the present disclosure, the spatial map event may be an object change event including addition, removal, or a change of a position, a direction, or a velocity of one or more objects in the spatial map.

The method according to exemplary embodiments of the present disclosure may further include obtaining position information, direction information, and velocity information of one or more trackable objects included in the spatial map from a core network or a location management service.

According to exemplary embodiments of the present disclosure, subscription procedures related to a spatial map-specific event may be provided.

Referring again to FIG. 10, a procedure in which an authorized spatial map consumer (VAL server or SEAL SM client) subscribes to a spatial map event is illustrated. This service may be provided by a SEAL SM server. The spatial map consumer may get notification information when the SM server detects a subscribed event.

The VAL server (or the SEAL SM client) may send a request message to the SEAL SM server to subscribe to the spatial map event (S510).

The request may include a requestor identifier (requestor ID), security credentials, a notification endpoint, target spatial map(s), notification intervals, a duration for which an event is notified, and an event to subscribe which triggers a notification.

The request message may also include a list of spatial map layers with corresponding layer IDs to subscribe to an event related to spatial map layering information.

The requestor (the VAL server or the SEAL SM client) may subscribe to one or more of the following events.

A “changes of objects” event may indicate that the SM server is to notify the requestor when a change of an object is detected.

A notification triggering criterion for the “changes of objects” event may include an added or removed object, or a position, a velocity, or a direction change of a spatial map object.

A “layers modification” event may indicate that the SM server is to notify the requestor when any layer in the spatial map is added, updated, or removed.

A “spatial map ready” event may indicate that the SM server is to notify the requestor when the SEAL SM server has sufficient information to map all objects related to an area of interest of a spatial map and the spatial map is ready to provide a service (e.g., employed for localization). This event may be used when a result IE in a Create spatial map response indicates “in-progress.”

In exemplary embodiments of the present disclosure, an object may be a UE. In alternative exemplary embodiments of the present disclosure, a movable and trackable object may include a non-3GPP device trackable by a UE or a gNB.

The following operations may be performed as a part of operation S520 or may be performed before or after operation S520.

The SEAL SM server may authorize the VAL server (or the SEAL SM client) and may validate the request.

When authorized, the SEAL SM server may determine target spatial map(s) by using spatial map ID(s), an area of interest, and/or location information provided in the request.

Thereafter, the SEAL SM server may add the requestor into a subscriber list of the corresponding event. The SEAL SM server may start monitoring for the event.

For the “changes of objects” event, the SM server may obtain a position, a direction, and a velocity of a trackable object from a 5GS or a SEAL Location Management service.

The SEAL SM server may send a response message with a result (S530).

When the subscription request is successful, the response message may include a subscription ID.

Otherwise, the response message may include information indicating failure and a reason for failure.

In exemplary embodiments of the present disclosure, information elements (IEs) included in a spatial map subscription request may be represented as shown in Table 8 below.

TABLE 8

| Information element | Status | Description |
|---|---|---|
| Requestor identifier | M | The identifier of the requestor (e.g., VAL |
| | | server or VAL user) |
| Security credentials | M | The security credentials of the requestor. |
| Application service ID | M | ID of the requesting VAL application |
| | | service |
| Expiry time | O | Proposed subscription expiry time |
| Notification endpoint | M | Indicates the address (e.g., IP address, |
| | | FQDN, URI) where the notifications should |
| | | be sent. |
| Target spatial map(s) | M | Spatial map(s) to subscribe |
| > List of spatial map IDs | O | ID(s) of the spatial map(s) to subscribe |
| | (NOTE 1) | |
| > Area of interest | O | Three-dimensional area information to |
| | (NOTE 1) | discover spatial map(s) to subscribe |
| > Location information | O | Location, orientation and pose information |
| | (NOTE 1) | that is used to identify relevant spatial maps |
| | | to subscribe. |
| List of events | M | Events to subscribe. Each element |
| | | includes the information described below. |
| > Event type | O | List of events to subscribed. Possible |
| | | values are: |
| | | Change of objects |
| | | Layers modification |
| | | spatial map ready |
| | | UE-object association |
| > specified objects | O | List of specified objects for “change of |
| | | objects” event |
| > Triggering criteria | O | Specifies the condition to determine |
| | | whether the event is occurred, e.g. Spatial |
| | | map is employed and ready for localization |
| | | service. |
| >> Changes in objects | O | Triggers notification if any or specified (or |
| | (NOTE 2) | specified type of) objects are added, |
| | | removed, changed in position, direction, |
| | | velocity, UE-object association, etc. |
| >> Layer IDs | O | List of layers. Triggers notification if any or |
| | (NOTE 2) | specified spatial map layer change is |
| | | detected |
| > Notification intervals | O | Specifies when to notify the detected event, |
| | | Possible values are: |
| | | Event based (e.g., promptly); Or |
| | | Periodically (with minimum time between |
| | | consecutive notifications) |
| | | Intervals (i.e. minimum time between |
| | | consecutive notifications) |
| > Interval time | O | Time between consecutive notifications |
| | | (applicable only if notification intervals is set |
| | | to intervals. |
| Tracking end condition | O | Specifies the condition until when events |
| | | for the tracking objects are notified (e.g. as |
| | | long as tracking objects stay in the spatial |
| | | map, etc.) |

NOTE 1:
At least one of the sub-elements shall be provided.
NOTE 2:
At least one of the sub-elements shall be provided.

In exemplary embodiments of the present disclosure, information elements (IEs) included in a spatial map subscription response may be represented as shown in Table 9 below.

TABLE 9

| Information | | |
|---|---|---|
| element | Status | Description |
| Result | M | Result of the subscribe spatial map event |
| | | request |
| Subscription | O | Identity of the subscription |
| Id (NOTE) | | |
| Expire time | O | Subscription expire time |
| Failure cause | O | Indicates reason for the failure. |

NOTE:
This IE is mandatory when Result IE indicates success.

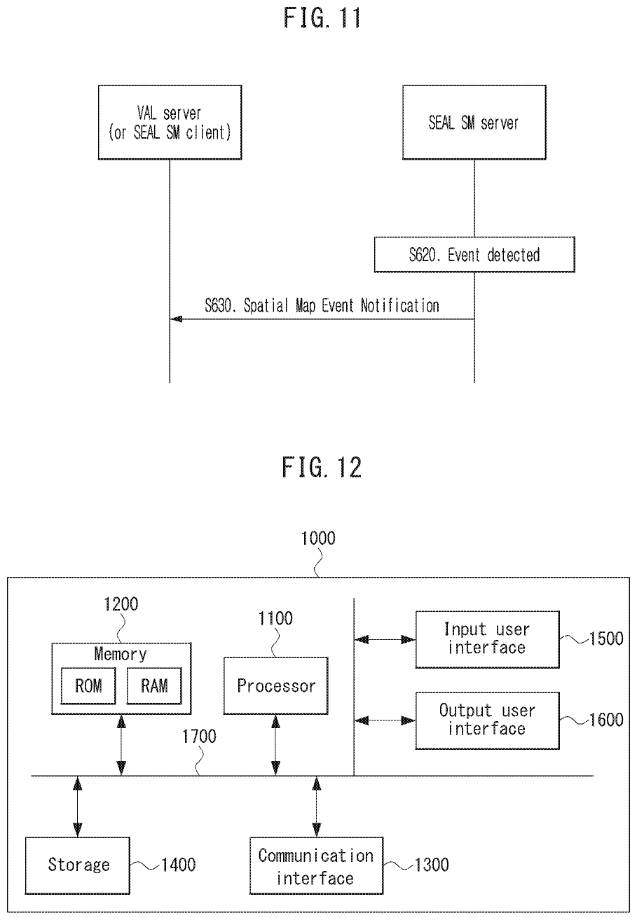

FIG. 11 is a diagram illustrating a Spatial Map event notification procedure according to an exemplary embodiment of the present disclosure.

As shown in FIG. 11, a method according to an exemplary embodiment of the present disclosure may further include detecting a change of one or more trackable objects based on position information, direction information, and velocity information of the one or more trackable objects (S620); and transmitting, to a subscriber, a notification message indicating the detected change of the one or more trackable objects (S630).

In the method according to exemplary embodiments of the present disclosure, the notification message may further include an estimated duration of tracking indicating a period during which the one or more trackable objects remain in the spatial map.

The method according to exemplary embodiments of the present disclosure may further include performing mobility prediction of the one or more trackable objects based on data analytics using the position information, the direction information, and the velocity information of the one or more trackable objects. The notification message may be generated based on the mobility prediction, and monitoring of the spatial map event may be performed until a tracking end condition for the one or more trackable objects is satisfied.

Referring again to FIG. 11, a notify spatial map event operation between an authorized spatial map consumer (VAL server or SEAL LM client) and a SEAL SM server is illustrated.

The SEAL SM server may detect an event triggering notification to subscribers for a corresponding event.

When the subscribed event is “changes of objects,” the SM server may detect any change of spatial map objects.

For the trackable objects, based on data analytics on a position, a direction, and a velocity, the SM server may perform mobility prediction of the trackable objects and may estimate a duration for which the corresponding objects stay in the spatial map.

When UE-object association information is provided, the SEAL SM server may use this information to determine whether a detected spatial map object is associated with a UE.

A method for performing mobility prediction of a trackable object and a method for estimating a duration of object tracking may vary depending on implementation, and are not construed as being limited to a specific exemplary embodiment.

When the subscribed event is “layers modification,” the SM server may detect any change of spatial map layer information.

When the subscribed event is “spatial map ready,” the SM server may detect when the SEAL SM server has sufficient information to map all objects related to an area of interest of a spatial map and the spatial map is ready to provide a service (e.g., employed for localization).

The SM server may determine whether a detected event matches a trigger criterion and may notify subscribers accordingly.

The SEAL SM server may notify VAL servers (or SEAL SM clients) subscribing to a corresponding event.

Notification of a spatial map event may include a subscription identifier (subscription ID) and event-specific information.

When the event is “changes of objects,” a spatial map notification message may include information on a detected trigger event, for example, an added or removed object, a position or direction change of objects in a spatial map, UE-object association, and so on.

When the event is “layer modification,” the notification message may include a list of all layers for the spatial map.

In exemplary embodiments of the present disclosure, information elements (IEs) included in a spatial map event notification may be represented as shown in Table 10 below.

TABLE 10

| Information element | Status | Description |
|---|---|---|
| Subscription ID | M | Subscription ID for the event |
| Notification information | M | Specifies what matches the triggering |
| | | notification condition, including related |
| | | information |
| > Spatial map ID | M | ID of the spatial map for which the event is |
| | | detected |
| > Event type | M | Type of event detected. One of the event as |
| | | specified in Table 9.3.6.3.1-1. |
| >> Changed object | O | Information on the object which triggered the |
| | (NOTE 1) | notification |
| >>> Object ID | O | ID of the changed object |
| | (NOTE 3) | |
| >>> Association ID | O | Identifier of the UE-object association. |
| | (NOTE 3) | |
| >>> UE ID | O | Identifier of the UE with an associated object. |
| | (NOTE 3) | |
| >>> Type of change | O | Specifies the detected type of change for the |
| | | object (e.g., added, removed, or changed |
| | | position, direction, velocity, or UE-object |
| | | association) |
| >>> Estimated duration of | O | Estimated duration for which the object being |
| tracking | | tracked stays in the spatial map. Applicable |
| | | for tracking objects. |
| >>> Object mobility | O | Information predicting the mobility of the |
| prediction | | object being tracked. Applicable for tracking |
| | | objects. |
| >>> Changed object | O | A container to carry the changed object |
| information | | specific information |
| >> list of layers (NOTE 2) | O | Information about layers for the spatial map. |

NOTE 1:
This IE is applicable for “Change of objects” event type.
NOTE 2:
This IE is applicable for “Layer modification” event type.
NOTE 3:
This IE is applicable for “UE-object association” event type.

According to exemplary embodiments of FIGS. 1 to 11, a spatial anchor may indicate an association between a physical location in a 3D space and service information. In the contrasted related art, a location of a spatial anchor is a fixed 3D space position irrelevant to an intention of a spatial anchor producer and consumer.

Spatial mapping may model and track a stationary object and a moving object. For a stationary object, spatial mapping may be required to estimate the number of objects, object types, and positions. For a moving object, spatial mapping may be required to determine a position, an object type, a direction, and a speed.

A spatial anchor producer may intend to create a spatial anchor on an object (e.g., a product on a store display shelf, an autonomous mobile robot (AMR), and so on). For such a case, a primary intention of creating the spatial anchor may be associating an application service with the object, rather than associating an anchor with a fixed 3D location as in the related art.

In the case of a stationary object, a location of a spatial anchor may be a fixed 3D space position. However, when a moving object or a trackable object moves, a spatial anchor with a fixed 3D space position may not associate a corresponding service. Accordingly, a spatial anchor producer may intend to create a spatial anchor on an object moving in a spatial map.

A method proposed in the present disclosure may associate application service information with a trackable object in a spatial map.

Trackable objects may be moving or may intermittently change positions, but there may still be a need to track locations of the objects.

In this case, an IE defining a spatial anchor may include not only a fixed 3D coordination position of the spatial anchor but also an identifier of an object on which the spatial anchor is configured.

Position tracking according to movement of the object on which the spatial anchor is configured is performed in a spatial map management server, and a spatial anchor management server may subscribe to a spatial map management (SM) server and may recognize a position.

When an object is removed from a spatial map, the SM server may be required to notify a spatial anchor management server (SAn) of the removal.

Any change of an existing spatial anchor may be managed by the SAn server, and the SAn server may operate independently and solely irrespective to the SM server.

In exemplary embodiments of the present disclosure, a method for identifying a target object may be implemented based on an interaction among consumers, that is, an interaction between a metaverse application service user (e.g., cheese seller or AMR owner) and a VAL server providing a metaverse application service.

In exemplary embodiments of the present disclosure, for the identified target object, a method for searching/discovering a target object ID and a corresponding spatial map may be implemented based on an interaction between a VAL server providing a metaverse application service and an SM server.

For example, a procedure for discovering an SM (spatial map) and obtaining SM information may be used. When a corresponding SM is not discovered/found, the VAL server may start a procedure for creating an SM.

When a target object is not discovered/found within the corresponding SM, the VAL server may start a procedure for updating the SM.

Referring to FIGS. 1 to 11 together with FIG. 12 to be described later, an entity associated with a mobile communication network system, a spatial map management server, and/or a spatial anchor management server according to exemplary embodiments of the present disclosure, or an entity related to a location-based service procedure, may include a memory 1200 storing one or more instructions readable by a computer; and a processor 1100 executing the one or more instructions.

FIG. 12 is a conceptual diagram illustrating an example of a generalized computing system in which a vertical application layer (VAL) server entity, a spatial map management server (SMS) entity, a spatial map client (SMC) entity, a spatial anchor management server (SAS) entity, a spatial anchor client (SAC) entity, an entity within a core network, or a part thereof capable of performing at least a part of procedures of FIGS. 1 to 11 is implemented.

According to exemplary embodiments of the present disclosure, at least a part of operations of the spatial map management server and the spatial anchor management server performed in a VAL server, a SEAL server, a SEAL client, and so on, may be executed by a computing system 1000 of FIG. 12.

As shown in FIG. 12, a computing system 1000 according to an exemplary embodiment of the present disclosure may include a processor 1100, a memory 1200, a communication interface 1300, a storage device 1400, an input interface 1500, an output interface 1600, and a bus 1700.

The computing system 1000 according to an exemplary embodiment of the present disclosure may include at least one processor 1100 and a memory 1200 storing instructions instructing the at least one processor 1100 to perform at least one operation. At least some operations of the method according to exemplary embodiments of the present disclosure may be performed by the at least one processor 1100 loading and executing the instructions from the memory 1200.

The processor 1100 may indicate a central processing unit (CPU), a graphics processing unit (GPU), or a dedicated processor in which methods according to exemplary embodiments of the present disclosure are performed.

Each of the memory 1200 and the storage device 1400 may include at least one of a volatile storage medium and a non-volatile storage medium. For example, the memory 1200 may include at least one of a read only memory (ROM) and a random access memory (RAM).

In addition, the computing system 1000 may include a communication interface 1300 performing communication through a network.

In addition, the computing system 1000 may further include the storage device 1400, the input interface 1500, the output interface 1600, and so on.

In addition, respective components included in the computing system 1000 may be connected by the bus 1700 and may communicate with each other.

A spatial map management server according to exemplary embodiments of the present disclosure may be implemented as at least one computing system 1000. Operations of the spatial map management server illustrated in FIGS. 1 to 11 may be performed by the processor 1100 executing at least one program instruction stored in the memory 1200 within the computing system 1000.

A spatial anchor management server according to exemplary embodiments of the present disclosure may be implemented as at least one computing system 1000. Operations of the spatial anchor management server illustrated in FIGS. 1 to 11 may be performed by the processor 1100 executing at least one program instruction stored in the memory 1200 within the computing system 1000.

According to exemplary embodiments of the present disclosure, a communication network system providing location information regarding a UE or an object within an area of interest may be a 5G/6G core network.

According to exemplary embodiments of the present disclosure, a communication network system providing location information regarding a UE or an object within an area of interest may include at least one entity, and the at least one entity may include a memory 1200 storing one or more instructions readable by a computer; and a processor 1100 executing the one or more instructions.

It is possible to implement operations of the method according to exemplary embodiments of the present disclosure as a program or code readable by a computer in a computer-readable recording medium. The computer-readable recording medium includes all types of recording device storing data which can be read by a computer system. Further, the computer-readable recording medium may be distributed over computer systems connected through a network, so that the computer-readable program or codes may be stored and executed in a distributed manner.

Further, the computer-readable recording medium may include a hardware device specially configured to store and execute a program command, such as a ROM, a RAM, a flash memory, etc. The program command may include not only a machine language code such as one generated by a compiler, but also a high-level language code executable by a computer by using an interpreter, etc.

Some aspects of the present disclosure have been described in the context of an apparatus, but some aspects may also represent description according to a corresponding method, wherein a block or an apparatus corresponds to a method process or a feature of a method process. Similarly, aspects described in the context of a method may also be represented as a feature of a corresponding block or item or a corresponding apparatus. Some or all of the method processes may be performed by (or by using) a hardware apparatus such as, for example, a microprocessor, a programmable computer, or an electronic circuit. In some exemplary embodiments, at least one of the most important method processes may be performed by such an apparatus.

In exemplary embodiments, a programmable logic device (for example, a field programmable gate array) may be used to perform some or all of functions of the methods described herein. In exemplary embodiments, the field programmable gate array may operate together with a microprocessor to perform one of the methods described herein. In general, the methods are preferably performed by a certain hardware device.

Although the present disclosure has been described above with reference to preferred exemplary embodiments of the present disclosure, those skilled in the art will understand that the present disclosure may be variously modified and changed within a range not departing from the spirit and region of the present disclosure described in the following claims.

What is claimed is:

1. A method performed by a spatial anchor management server, the method comprising:
receiving a request for creating a spatial anchor associated with an object in a spatial map, the request including spatial map information; and
creating the spatial anchor associated with the object based on the spatial map information included in the request, wherein the spatial map information includes:
a spatial map identifier identifying the spatial map; and
an object identifier identifying the object included in the spatial map.

2. The method of claim 1, in the creating of the spatial anchor associated with the object, wherein the spatial anchor is created based on spatial map position information including one or more of:
the spatial map identifier;
a spatial map layer identifier and localization information corresponding to the spatial map layer identifier; or
the object identifier.

3. The method of claim 2, wherein the localization information includes a three-dimensional position and a pose of the object.

4. The method of claim 1, further comprising:
receiving a request for discovering a spatial anchor of interest, the request for discovering the spatial anchor of interest including a request identifier, and a spatial anchor discovery filter; and
transmitting a response for discovering the spatial anchor of interest, the response including one or more of:
position information of the spatial anchor of interest in three-dimensional space; or
spatial map position information including a corresponding spatial map corresponding to the spatial anchor of interest.

5. The method of claim 4, further comprising:
validating the request for discovering the spatial anchor of interest based on the request identifier and security credential of a requestor included in the request for discovering the spatial anchor of interest.

6. The method of claim 4, wherein the spatial anchor discovery filter includes one or more of:
an identifier of the spatial anchor of interest;
an area of interest;
a service identifier identifying a vertical application layer (VAL) service;
an associated name indicating a name associated with the spatial anchor of interest; or
application specific spatial anchor information.

7. The method of claim 4, wherein the spatial map position information included in the response includes one or more of:
a spatial map identifier identifying the corresponding spatial map;
a spatial map layer identifier identifying a layer being included in the corresponding spatial map and including the spatial anchor of interest; or
an object identifier identifying an object associated with the spatial anchor of interest being included in the corresponding spatial map.

8. The method of claim 4, further comprising:
when the spatial anchor of interest is associated with a movable and trackable object,
obtaining, from a spatial map management server, current position information of the movable and trackable object associated with the spatial anchor of interest;
wherein the response for discovering the spatial anchor of interest further includes the spatial map position information comprising the current position information of the movable and trackable object.

9. The method of claim 1, further comprising:
receiving a request for subscribing to a spatial anchor of interest, the request for subscribing including a spatial anchor filter including an area of interest; and
when the spatial anchor of interest is associated with a movable and trackable object,
obtaining, from a spatial map management server, current position information of the movable and trackable object associated with the spatial anchor of interest;
wherein whether the spatial anchor of interest is within the area of interest is determined based on the current position information, and
wherein a response to the request for subscribing includes information associated with the spatial anchor of interest based on the current position information.

10. The method of claim 9, further comprising:
monitoring a location of a user equipment (UE) and a position of the movable and trackable object associated with the spatial anchor of interest; and
determining whether the spatial anchor of interest is in-range or out-of-range of the UE based on the current position information of the movable and trackable object obtained from the spatial map management server, and mobility prediction information of the movable and trackable object obtained from the spatial map management server.

11. A method performed by a spatial map management server, the method comprising:
receiving a request for subscribing to a spatial map event, the request including a spatial map identifier identifying a spatial map and event information; and
transmitting a response to the request for subscribing to the spatial map event,
wherein the response includes one or more of:
a subscription identifier based on a successful validation of the request; or
an indication of failure and a reason for failure for a validation of the request.

12. The method of claim 11, further comprising:
authorizing a requestor based on a requestor identifier and security credential for the requestor included in the request; and
validating the request based on the authorization of the requestor.

13. The method of claim 11, wherein the spatial map event includes a “change of objects” event indicating that one or more objects in the spatial map are added, removed, or changed in position, direction, or velocity.

14. The method of claim 11, further comprising:
obtaining position information, direction information, and velocity information of one or more trackable objects included in the spatial map from a core network or a location management service.

15. The method of claim 11, further comprising:
detecting a change of the one or more trackable objects in the spatial map based on the position information, the direction information, and the velocity information of the one or more trackable objects; and
transmitting a notification message indicating the detected change of the one or more trackable objects to a subscriber.

16. The method of claim 15, wherein the notification message further includes estimated duration of tracking indicating a duration for which the one or more trackable objects remain in the spatial map.

17. The method of claim 15, further comprising:
performing mobility prediction of the one or more trackable objects based on data analytics using the position information, the direction information, and the velocity information of the one or more trackable objects,
wherein the notification message is generated based on the mobility prediction, and
wherein monitoring of the spatial map event is performed until a tracking end condition associated with the one or more trackable objects is satisfied.

18. A mobile communication network system comprising:
a spatial anchor management server, being operated by at least one entity,
wherein the spatial anchor management server is configured to:
receive a request for creating a spatial anchor associated with an object in a spatial map, the request including spatial map information; and
create the spatial anchor associated with the object based on the spatial map information,
wherein the spatial map information includes a spatial map identifier identifying the spatial map and an object identifier identifying the object included in the spatial map.

19. The mobile communication network system of claim 18, wherein the spatial anchor management server is further configured to:
receive a request for discovering a spatial anchor of interest, the request including a spatial anchor discovery filter;
validate the request for discovering the spatial anchor of interest based on a request identifier and a security credential of a requestor included in the request; and
transmit a response for discovering the spatial anchor of interest.

20. The mobile communication network system of claim 18, wherein the spatial anchor management server is further configured to:
receive a request for subscribing to a spatial anchor of interest, the request including a spatial anchor filter including an area of interest; and
when the spatial anchor of interest is associated with a movable and trackable object,
obtain, from a spatial map management server, current position information of the movable and trackable object associated with the spatial anchor of interest,
wherein a response to the request for subscribing includes information associated with the spatial anchor of interest based on the current position information.
